(19) United States
(12) Patent Application Publication
(10) Pub. No.: US 2014/0292560 A1
(43) Pub. Date: Oct. 2, 2014

(54) PEDESTRIAN DETECTING DEVICE FOR VEHICLE, PEDESTRIAN PROTECTION SYSTEM FOR VEHICLE AND PEDESTRIAN DETERMINATION METHOD

(71) Applicants: Tomoya Kawasaki, Miyoshi-shi (JP); Makoto Nakai, Nagoya-shi (JP)

(72) Inventors: Tomoya Kawasaki, Miyoshi-shi (JP); Makoto Nakai, Nagoya-shi (JP)

(73) Assignee: TOYOTA JIDOSHA KABUSHIKI KAISHA, Toyota-shi, Aichi-ken (JP)

(21) Appl. No.: 14/356,053

(22) PCT Filed: Oct. 30, 2012
(86) PCT No.: PCT/IB12/02174

§ 371 Date: May 2, 2014

(30) Foreign Application Priority Data
Nov. 2, 2011 (JP) 2011-241595

(51) Int. Cl. G01S 13/93

(52) U.S. Cl. CPC G01S 13/931
USPC 342/146

(57) ABSTRACT

A pedestrian detecting device mounted on a vehicle includes: a transmission unit that irradiates an electromagnetic wave to an area around a vehicle; a receiving unit that receives a reflected wave caused by reflection of the electromagnetic wave from an obstacle; a storage unit that stores data of the reflected wave received by the receiving unit; and a control unit that reads the data of the reflected wave, stored in the storage unit, and that calculates a variance of an intensity of the reflected wave, wherein the control unit determines that the obstacle is a pedestrian when the calculated variance of the intensity of the reflected wave is larger than or equal to a reference value, and, after the control unit determines that the obstacle is a pedestrian, the control unit identifies that the same obstacle is a pedestrian and outputs information regarding a position of the pedestrian.

### BACKGROUND OF THE INVENTION

1. Field of the Invention

The invention relates to a pedestrian detecting device for vehicle, a pedestrian protection system for vehicle and a pedestrian determination method.

2. Description of Related Art

A research on a technique for detecting the type of an obstacle (vehicle, pedestrian, or the like) by analyzing an output from a radar device mounted on a vehicle has been proceeding.

For example, Japanese Patent Application Publication No. 2004-361154 (JP 2004-361154 A) describes a device that reads information about the intensity of reflected wave received from an object by receiving means. When the intensity of reflected wave received from the object repeatedly increases and decreases at a predetermined period, the device determines the object as a pedestrian.

However, it is difficult for the device described in JP 2004-361154 A to determine whether the intensity of reflected wave actually repeatedly increases and decreases at the predetermined period. In addition, when a pedestrian is stationary, fluctuations in the intensity of received reflected wave decreases, so the pedestrian may be lost.

### SUMMARY OF THE INVENTION

The invention provides a pedestrian detecting device for vehicle, and the like, that are able to further reliably track a pedestrian.

A first aspect of the invention provides a pedestrian detecting device for vehicle. The pedestrian detecting device for vehicle includes: a transmission unit that irradiates an electromagnetic wave to an area around a vehicle; a receiving unit that receives a reflected wave caused by reflection of the electromagnetic wave from an obstacle; a storage unit that stores data regarding the reflected wave received by the receiving unit; and a control unit that reads the data, stored in the storage unit, and that outputs positional information about the obstacle, wherein the control unit calculates a variance of an intensity of the reflected wave, the control unit determines that the obstacle is a pedestrian when the calculated variance of the intensity of the reflected wave is larger than or equal to a reference value, and the control unit outputs information about a position of the pedestrian.

According to the first aspect of the invention, it is possible to further reliably track a pedestrian.

A second aspect of the invention provides a pedestrian detecting device for vehicle. The pedestrian detecting device for vehicle includes: a transmission unit that irradiates an electromagnetic wave to an area around a vehicle; a receiving unit that receives a reflected wave caused by reflection of the electromagnetic wave from an obstacle; a storage unit that stores data regarding the reflected wave received by the receiving unit; and a control unit that reads the data, stored in the storage unit, and that outputs positional information about the obstacle, wherein the control unit calculates a variance of an intensity of the reflected wave, the control unit determines that the obstacle is a pedestrian when a variation of the calculated variance of the intensity of the reflected wave in a set period of time is larger than or equal to a reference value, and the control unit outputs information about a position of the pedestrian.

According to the second aspect of the invention, it is possible to further reliably track a pedestrian.

In the first or second aspect of the invention, the control unit may identify the same obstacle as the pedestrian during a set period of time after the control unit determines that the obstacle is the pedestrian, and may output the information about the position of the pedestrian.

In the first or second aspect of the invention, the control unit may identify a presence of an obstacle when the intensity of the reflected wave is higher than or equal to a threshold, and, after the control unit determines that the obstacle is a pedestrian, the control unit may decrease the threshold applied for the same obstacle.

In the first or second aspect of the invention, the electromagnetic wave irradiated to the area around the vehicle may be a 24-GHz-band narrow band.

A third aspect of the invention provides a pedestrian protection system for vehicle. The pedestrian protection system for vehicle includes: the pedestrian detecting device for vehicle according to the first or second aspect; and a pedestrian protection apparatus that is activated on the basis of the information about the position of the obstacle, output from the pedestrian detecting device for vehicle.

According to the third aspect of the invention, it is possible to further reliably track a pedestrian and appropriately activate the pedestrian protection apparatus.

A fourth aspect of the invention provides a pedestrian determination method. The pedestrian determination method includes: irradiating an electromagnetic wave to an area around a vehicle; receiving a reflected wave caused by reflection of the electromagnetic wave from an obstacle; storing data regarding the reflected wave; reading the data and calculating a variance of an intensity of the reflected wave; and when the variance of the intensity of the reflected wave is larger than or equal to a reference value, determining that the obstacle is a pedestrian.

A fifth aspect of the invention provides a pedestrian determination method. The pedestrian determination method includes: irradiating an electromagnetic wave to an area around a vehicle; receiving a reflected wave caused by reflection of the electromagnetic wave from an obstacle; storing data regarding the reflected wave; reading the data and calculating a variance of an intensity of the reflected wave; and when a variation in the variance of the intensity of the reflected wave in a set period of time is larger than or equal to a reference value, determining that the obstacle is a pedestrian.

According to the fourth and fifth aspects of the invention, it is possible to further reliably determine a pedestrian.

According to the invention, it is possible to provide the pedestrian detecting device for vehicle, and the like, that are able to further reliably track a pedestrian.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a system configuration example of a pedestrian protection system for vehicle according to a first embodiment of the invention;

FIG. 2 is a temporal variation in received electric power based on a reflected wave reflected from a pedestrian;

FIG. 3 is a temporal variation in received electric power based on a reflected wave reflected from a pedestrian;

FIG. 4 is a temporal variation in received electric power based on a reflected, wave reflected from a vehicle that gradually approaches a radar;

FIG. 5 is a flowchart according to the first embodiment;

FIG. 6 is another example of the flowchart according to the first embodiment; and

FIG. 7 is a flowchart according to a second embodiment.

### DETAILED DESCRIPTION OF EMBODIMENTS

Hereinafter, embodiments of the invention will be described with reference to the accompanying drawings.

### First Embodiment

Hereinafter, a pedestrian detecting device for vehicle according to a first embodiment of the invention and a pedestrian protection system for vehicle that utilizes the pedestrian detecting device for vehicle will be described with reference to the accompanying drawings.

### Basic Configuration

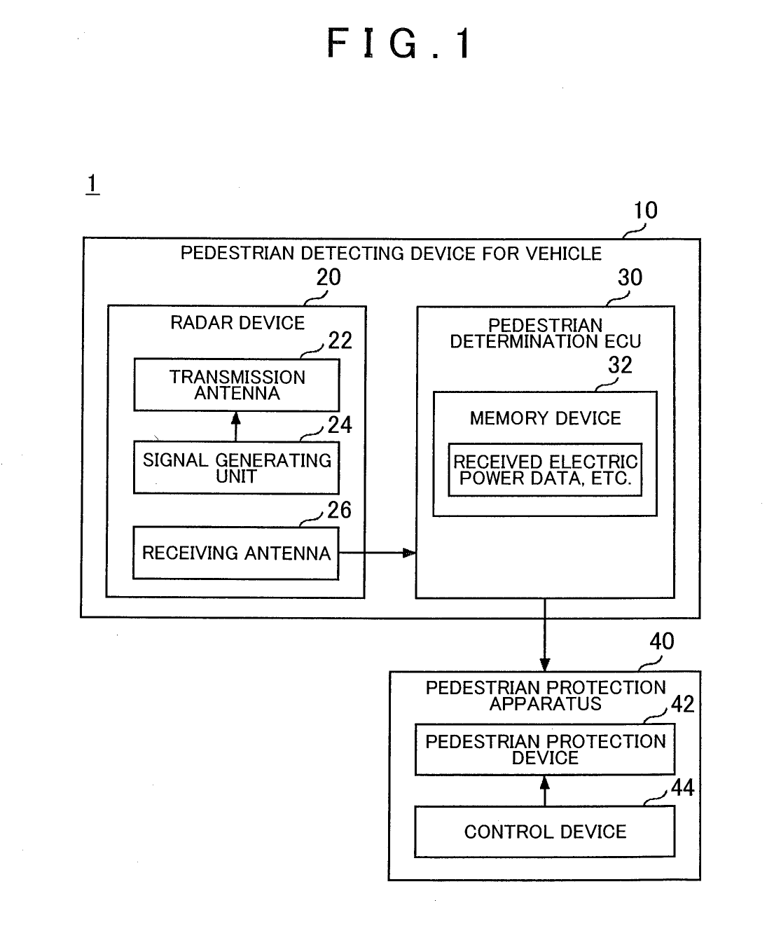

FIG. 1 is a system configuration example of the pedestrian protection system for vehicle 1 according to the first embodiment of the invention. The pedestrian protection system for vehicle 1 includes the pedestrian detecting device 10 and a pedestrian protection apparatus 40 as major components. In addition, the pedestrian detecting device for vehicle 10 includes a radar device 20 and a pedestrian determination electronic control unit (ECU) 30.

The radar device 20 is a narrow band (NB) radar that uses an electromagnetic wave in, for example, 24 GHz band. The radar device 20 includes a transmission antenna 22, a signal generating unit 24 and a receiving antenna 26. The transmission antenna 22 irradiates an electromagnetic wave forward (or rearward, laterally, forward laterally, or the like). The signal generating unit 24 generates a transmission signal supplied to the transmission antenna 22. The receiving antenna 26 receives a reflected wave that is the electromagnetic wave reflected from an obstacle. The transmission antenna 22 may be integrated with the receiving antenna 26. Any system may be employed as the system of the radar device 20, and, for example, a frequency modulated-continuous wave (FM-CW) system is employed.

The FM-CW system is a system in which a transmission signal of which the frequency gradually increases and decreases is mixed with a received signal to generate a beat signal, the frequency of the beat signal (beat frequency) is identified for each of sections of an increasing portion at which the frequency of the transmission signal increases and a decreasing portion at which the frequency decreases, and a distance to a measured object (obstacle) and a direction and a relative velocity of the measured object are measured by applying digital beam forming (DBF), or the like, on the basis of the beat frequency of the increasing portion and the beat frequency of the decreasing portion.

The radar device 20 outputs data about the thus measured distance to the obstacle, relative velocity of the obstacle, received electric power of the receiving antenna 26, indicating the intensity of reflected wave received by the receiving antenna 26, and the like, to the pedestrian determination ECU 30.

The pedestrian determination ECU 30 is, for example, a microcomputer in which a central processing unit (CPU) and a memory device 32, such as a read only memory (ROM) and a random access memory (RAM), are connected to each other via a bus. The pedestrian determination ECU 30 further includes an auxiliary storage device, I/O ports, a timer, a counter, and the like. The auxiliary storage device is, for example, a hard disk drive (HDD), a digital versatile disk-recordable (DVD-R) drive, a compact disc-recordable (CD-R) drive and an electronically erasable and programmable read only memory (EEPROM). Programs to be executed by the CPU and data are stored in the auxiliary storage device.

The pedestrian determination ECU 30 stores data of the distance to an obstacle, the relative velocity of the obstacle and the electric power received by the receiving antenna 26, input from the radar device 20, in the memory device 32 as, for example, time-sequence data. Then, the pedestrian determination ECU 30 determines whether the obstacle detected by the radar device 20 is a pedestrian on the basis of the history of data about the electric power received by the receiving antenna 26. The pedestrian determination ECU 30 outputs data about the distance, direction and relative velocity of obstacles of which the electric power received by the receiving antenna 26 is higher than or equal to a threshold among the obstacles determined as pedestrians to the pedestrian protection apparatus 40. That is, the pedestrian determination ECU 30 recognizes the obstacles, of which the electric power received by the receiving antenna 26 is higher than or equal to the threshold, as actually present obstacles, and outputs data of the obstacles determined as pedestrians among the identified obstacles to the pedestrian protection apparatus 40. An example method of determining a pedestrian will be described later.

The pedestrian protection apparatus 40 includes a pedestrian protection device 42 and a control device 44. The pedestrian protection device 42 is, for example, an airbag system that deploys onto a bonnet, an actuator that raises the rear portion of the bonnet, a movable bumper, or the like. The control device 44 activates the pedestrian protection device 42 on the basis of a distance to a pedestrian, a direction and relative velocity of the pedestrian, and the like, input from the pedestrian determination ECU 30. For example, the control device 44 activates the pedestrian protection device 42 when the position of the pedestrian, acquired from the distance to the pedestrian and the direction of the pedestrian, falls within a predetermined area around the vehicle and the relative velocity indicates an approaching direction. The function of the control device 44 may be integrated with the pedestrian determination ECU 30. Here, raising the rear portion of the bonnet is to suppress an impact to a pedestrian.

### Pedestrian Determination

Hereinafter, a pedestrian determination process executed by the pedestrian determination ECU 30 will be described.

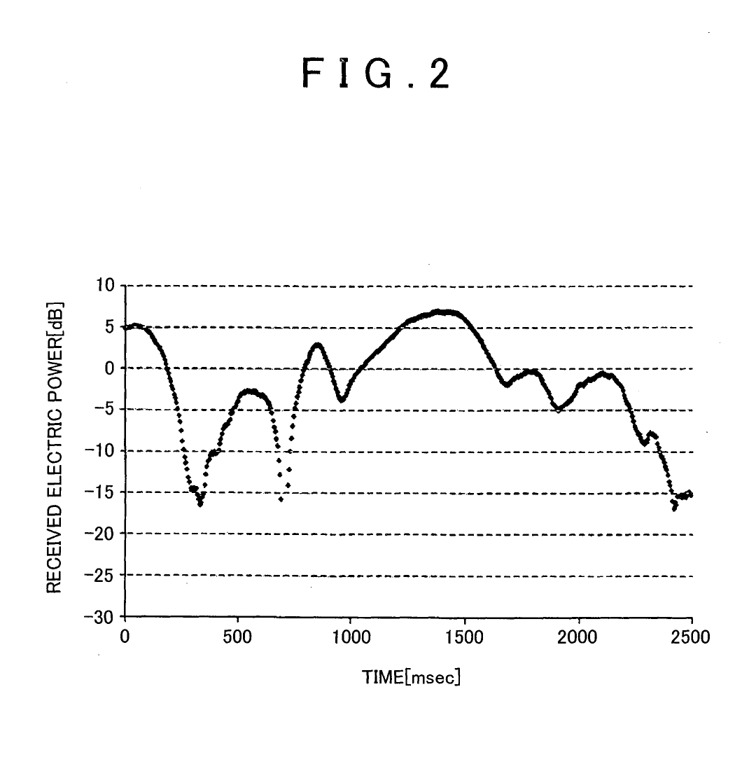

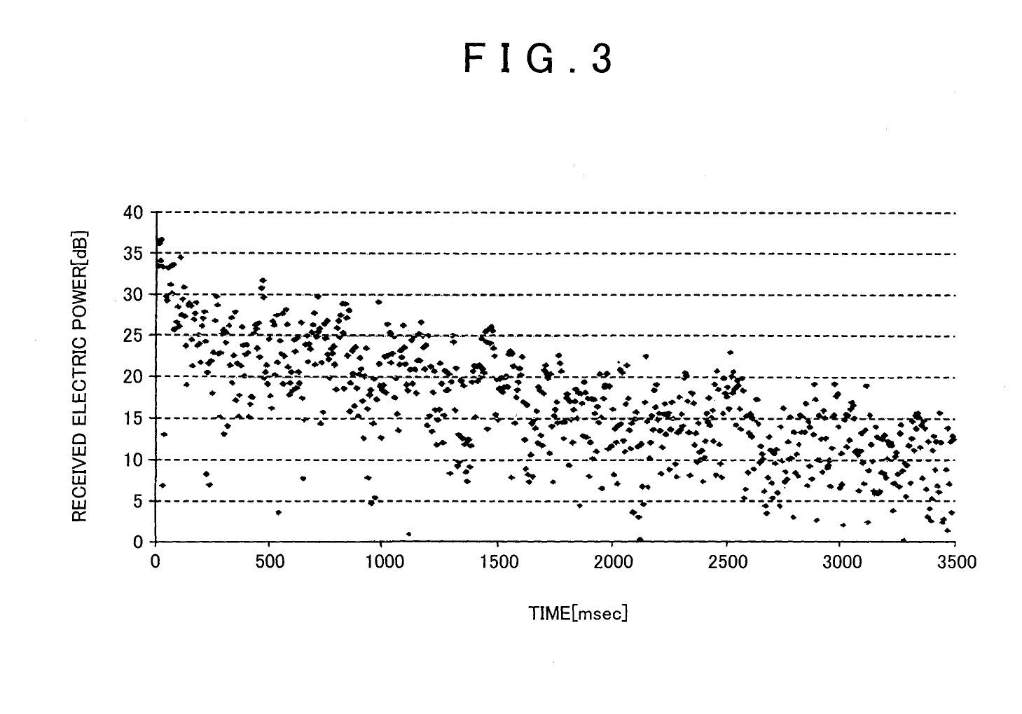

FIG. 2 and FIG. 3 are graphs that show temporal variations in electric power received by the receiving antenna 26, based on a reflected wave reflected from a pedestrian at the time when the 24-GHz-band NB radar irradiates an electromagnetic wave. FIG. 2 shows a temporal variation in electric power received by the receiving antenna 26 when a pedestrian is stationary at a set distance from the radar. FIG. 3 shows a temporal variation in electric power received by the receiving antenna 26 when a pedestrian is walking gradually away from the radar.

As shown in FIG. 2, when a pedestrian is stationary, the electric power received by the receiving antenna 26 periodically varies, and fluctuations in a short period of time are small. In addition, as shown in FIG. 3, when a pedestrian is walking, fluctuations in the electric power received by the receiving antenna 26 are large in a short period of time.

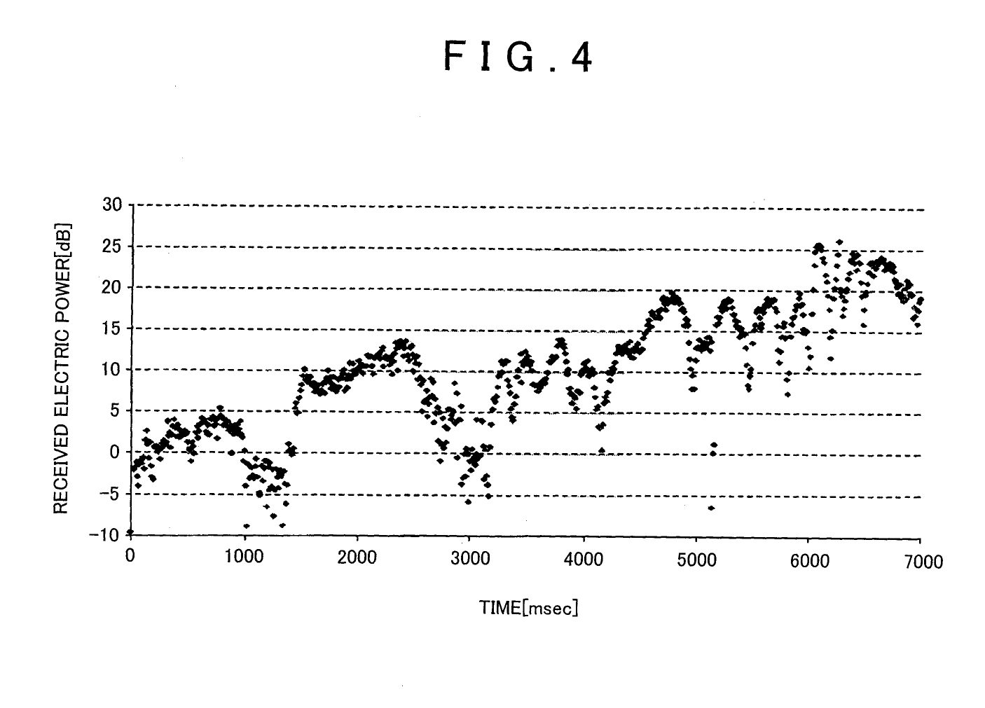

FIG. 4 is a graph that shows a temporal variation in electric power received by the receiving antenna 26, based on a reflected wave reflected from a vehicle that gradually approaches the radar. In FIG. 4, fluctuations are larger than those of the reflected wave from a stationary pedestrian and are smaller than those of the reflected wave from a walking pedestrian.

That is, the magnitude of fluctuations in the electric power received by the receiving antenna 26 is such a relationship that “walking pedestrian>moving vehicle>stationary vehicle≧stationary pedestrian”. The pedestrian determination ECU 30 according to the present embodiment determines whether the obstacle is a pedestrian by utilizing the above relationship.

Note that, different from the NB radar, in the case of an ultra-wide band (UWB) radar, even when a pedestrian is stationary, electric power received by the receiving antenna 26 exhibits larger fluctuations in a short period of time.

### Process Flow

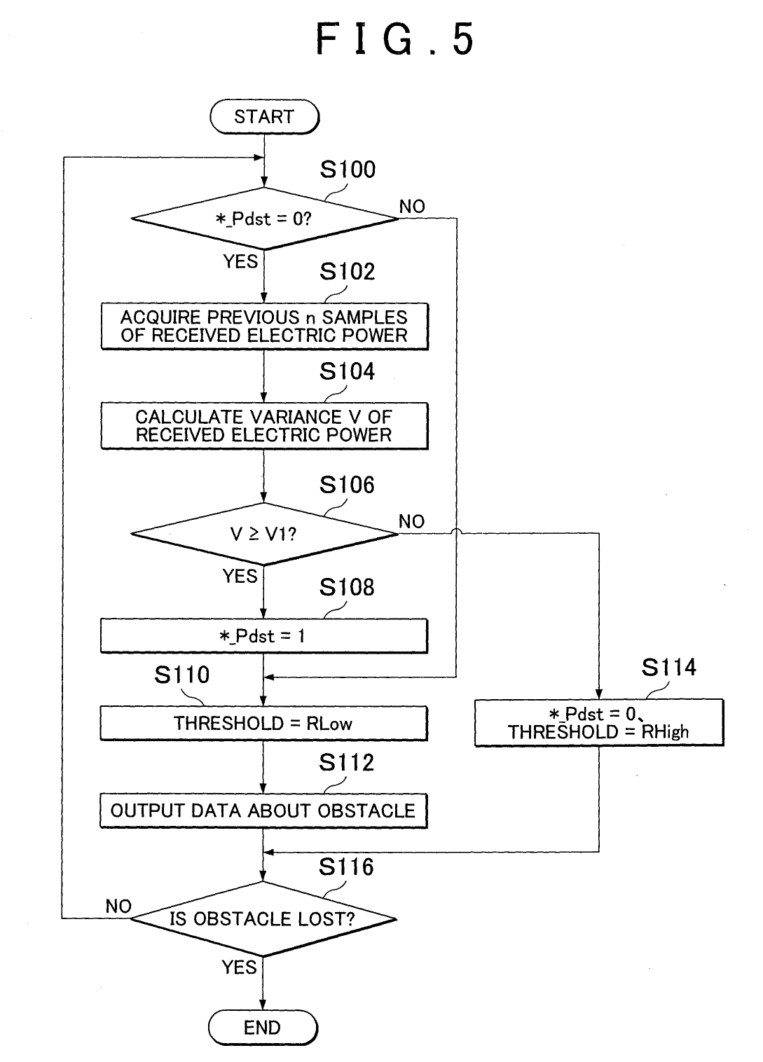

FIG. 5 is a flowchart according to the first embodiment. The flowchart shown in FIG. 5 is started at the time when a new obstacle is identified. In addition, when a plurality of obstacles are identified, the flowchart of FIG. 5 is, for example, executed for each obstacle.

First, the pedestrian determination ECU 30 determines whether a flag value *_Pdst for the intended obstacle is 0 (S100). The flag value *_Pdst is 0 or 1. When the flag value *_Pdst is 1, it indicates that the intended obstacle has been determined as a pedestrian before. The flag value *_Pdst is, for example, stored in a predetermined area of the memory device 32. The initial value of the flag value *_Pdst is set to 0.

When the flag value *_Pdst is 0, the pedestrian determination ECU 30 acquires previous n samples of the electric power received by the receiving antenna 26 from the memory device 32 (S102).

Subsequently, the pedestrian determination ECU 30 calculates a variance V of the previous n samples of the electric power received by the receiving antenna 26 (S104).

After that, the pedestrian determination ECU 30 determines whether the calculated variance V is larger than or equal to a reference value V1 (S106). The reference value V1 is set to a value that is slightly larger than an empirically obtained upper limit value of a variance of the electric power received by the receiving antenna 26, measured in the case where the obstacle is a vehicle.

When the variance V is larger than or equal to the reference value V1, the pedestrian determination ECU 30 determines that the intended obstacle is a pedestrian, and changes the flag value *_Pdst from 0 to 1 (S108).

When it is determined in S100 that the flag value *_Pdst of the intended obstacle is 1 or when the flag value *_Pdst is changed from 0 to 1 in S108, the pedestrian determination ECU 30 sets the threshold for determining the above-described obstacle to RLow (S110). The threshold Rlow is preset to a low value at which it is possible to continuously identify a stationary pedestrian.

Then, the pedestrian determination ECU 30 outputs data of distance, direction and relative velocity about the intended obstacle to the pedestrian protection apparatus 40 (S112).

On the other hand, when it is determined in S106 that the variance V is smaller than the reference value V1, the pedestrian determination ECU 30 keeps the flag value *_Pdst at 0, and sets the threshold for determining the obstacle to RHigh (S114). The threshold RHigh is larger than the threshold Rlow. In this way, when it is determined that the obstacle is not a pedestrian, the threshold for determining the obstacle is kept higher, so it is possible to suppress erroneous detection of an obstacle.

Note that, in the above description, only when it is determined that the obstacle is a pedestrian, data of distance, direction and relative velocity are output to the pedestrian protection apparatus 40; instead, in any cases, data of distance, direction and relative velocity may be output to the pedestrian protection apparatus 40 together with the flag value *_Pdst. The example embodiment of control may be modified into various forms.

Then, until the intended obstacle is lost (until the electric power received by the receiving antenna 26 becomes lower than the threshold; the same applies to the following description), the processes of S100 to S114 are repeatedly executed (S116).

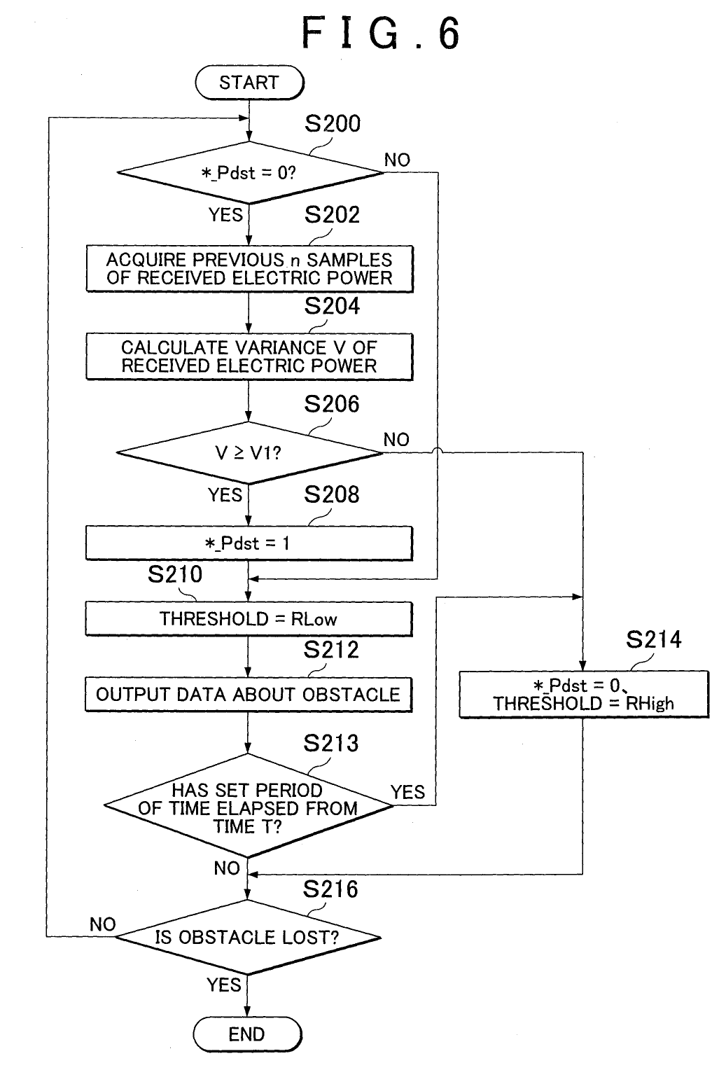

In addition, the flowchart of FIG. 5 may be modified as follows. FIG. 6 is another example of the flowchart that shows the flow of processes executed by the pedestrian determination ECU 30 according to the first embodiment. The flowchart shown in FIG. 6 is started at the time when a new obstacle is identified. In addition, when a plurality of obstacles are identified, the flowchart of FIG. 6 is, for example, executed for each obstacle.

First, the pedestrian determination ECU 30 determines whether a flag value * Pdst for the intended obstacle is 0 (S200). The flag value *_Pdst is 0 or 1. When the flag value *_Pdst is 1, it indicates that the intended obstacle has been determined as a pedestrian before. The flag value *_Pdst is, for example, stored in a predetermined area of the memory device 32. The initial value of the flag value *_Pdst is set to 0.

When the flag value *_Pdst is 0, the pedestrian determination ECU 30 acquires previous n samples of the electric power received by the receiving antenna 26 from the memory device 32 (S202).

Subsequently, the pedestrian determination ECU 30 calculates a variance V of the previous n samples of the electric power received by the receiving antenna 26 (S204).

After that, the pedestrian determination ECU 30 determines whether the calculated variance V is larger than or equal to a reference value V1 (S206). The reference value V1 is set to a value that is slightly larger than an empirically obtained upper limit value of a variance of the electric power received by the receiving antenna 26, measured in the case where the obstacle is a vehicle.

When the variance V is larger than or equal to the reference value V1, the pedestrian determination ECU 30 determines that the intended obstacle is a pedestrian, and changes the flag value *_Pdst from 0 to 1 (S208). At this time, time T at which the flag value *_Pdst is changed is stored in the memory device 32, or the like.

When it is determined in S200 that the flag value *_Pdst of the intended obstacle is 1 or when the flag value *_Pdst is changed from 0 to 1 in S208, the pedestrian determination ECU 30 sets the threshold for determining the above-described obstacle to RLow (S210). The threshold Rlow is preset to a low value at which it is possible to continuously recognize a stationary pedestrian.

Then, the pedestrian determination ECU 30 outputs data of distance, direction and relative velocity about the intended obstacle to the pedestrian protection apparatus 40 (S212).

After that, the pedestrian determination ECU 30 loads current time and determines whether a set period of time has elapsed from the time T stored in S208 (S213). When the set period of time has elapsed from the time T, the process proceeds to S214. Note that, instead of “whether a set period of time has elapsed”, it may be determined “whether the vehicle has travelled a predetermined distance”. In this case, at the time when the process of S208 is executed, measuring the travel distance of the vehicle is started.

On the other hand, when it is determined in S206 that the variance V is smaller than the reference value V1, the pedestrian determination ECU 30 keeps the flag value *_Pdst at 0 (when it is determined in S213 that the set period of time has elapsed, the pedestrian determination ECU 30 changes the flag value *_Pdst from 1 to 0), and sets the threshold for determining the obstacle to RHigh (S214). The threshold RHigh is larger than the threshold Rlow. In this way, when it is determined that the obstacle is not a pedestrian, the threshold for determining the obstacle is kept higher, so it is possible to suppress erroneous detection of an obstacle.

Note that, in the above description, only when it is determined that the obstacle is a pedestrian, data of distance, direction and relative velocity are output to the pedestrian protection apparatus 40; instead, in any cases, data of distance, direction and relative velocity may be output to the pedestrian protection apparatus 40 together with the flag value *_Pdst. The example embodiment of control may be modified into various forms.

Then, until the intended obstacle is lost, the processes of S200 to S214 are repeatedly executed (S216).

With the above-described pedestrian detecting device for vehicle 10 according to the present embodiment, after it is determined that an obstacle is a pedestrian on the basis of whether the variance V of the electric power received by the receiving antenna 26 is larger than or equal to the reference value V1, the obstacle is identified as a pedestrian until the obstacle is lost (or until a set period of time elapses). Therefore, it is possible to continuously track a stationary pedestrian, and it is possible to further reliably track a pedestrian.

In addition, after an obstacle is identified as a pedestrian, the obstacle is identified while decreasing the threshold, so it is possible to suppress an inconvenience that an obstacle determined as a pedestrian is lost.

In addition, with the pedestrian protection system for vehicle 1 according to the present embodiment, a pedestrian is identified by utilizing an output of the pedestrian detecting device for vehicle 10, so it is possible to further appropriately activate the pedestrian protection apparatus 40.

### Second Embodiment

Hereinafter, a pedestrian detecting device for vehicle according to a second embodiment of the invention and a pedestrian protection system for vehicle that utilizes the pedestrian detecting device for vehicle will be described with reference to the accompanying drawings.

### Basic Configuration

The basic configuration is similar to that of the first embodiment, so like reference numerals are assigned and the description is omitted.

### Pedestrian Determination

In the first embodiment, when the variance V of the electric power received by the receiving antenna 26 is larger than or equal to the reference value V1, it is determined that the intended obstacle is a pedestrian; whereas, in the second embodiment, when a difference ΔV in the variance V of the electric power received by the receiving antenna 26 in a set period of time is larger than or equal to a reference value V2, it is determined that the intended obstacle is a pedestrian.

### Process Flow

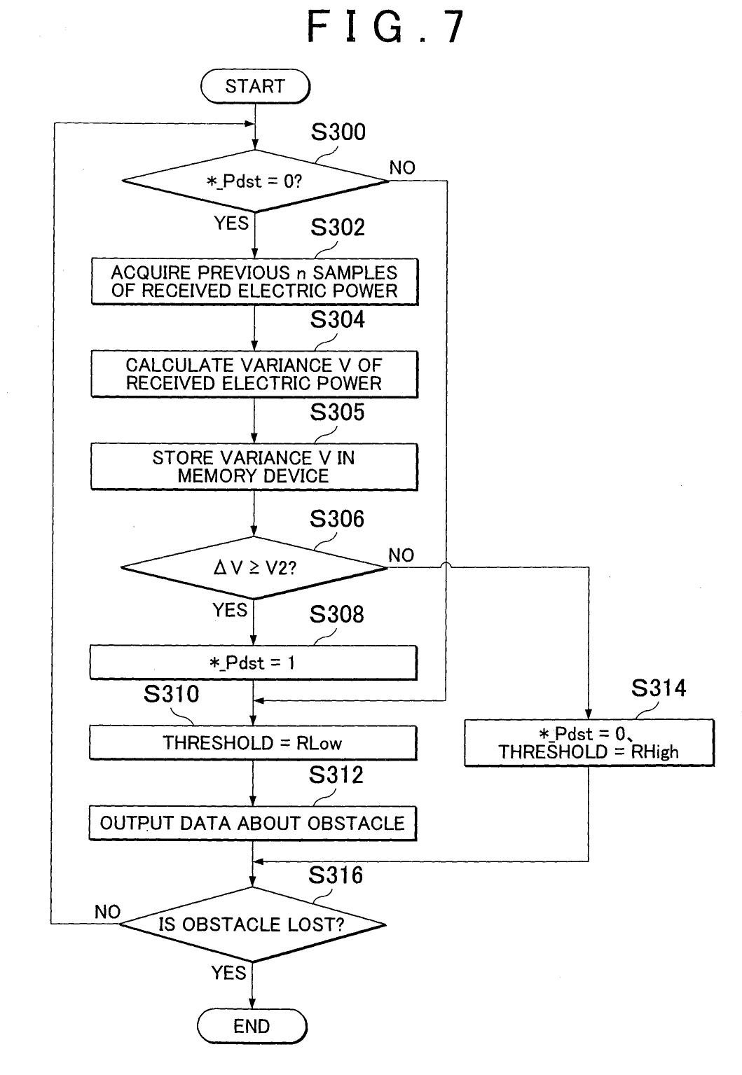

FIG. 7 is a flowchart that shows the flow of processes executed by the pedestrian determination ECU 30 according to the second embodiment. The flowchart shown in FIG. 7 is started at the time when a new obstacle is identified. In addition, when a plurality of obstacles are identified, the flowchart of FIG. 7 is, for example, executed for each obstacle.

First, the pedestrian determination ECU 30 determines whether a flag value *_Pdst for the intended obstacle is 0 (S300). The flag value *_Pdst is 0 or 1. When the flag value *_Pdst is 1, it indicates that the intended obstacle has been determined as a pedestrian before. The flag value *_Pdst is, for example, stored in a predetermined area of the memory device 32. The initial value of the flag value *_Pdst is set to 0.

When the flag value *_Pdst is 0, the pedestrian determination ECU 30 acquires previous n samples of the electric power received by the receiving antenna 26 from the memory device 32 (S302).

Subsequently, the pedestrian determination ECU 30 calculates a variance V of the previous n samples of the electric power received by the receiving antenna 26 (S304), and stores the variance V in the memory device 32 (S305).

After that, the pedestrian determination ECU 30 determines whether a difference ΔV between the calculated variance V and the variance V calculated before and stored in the memory device 32 is larger than or equal to the reference value V2 (S306). The reference value V2 is set to a value that is slightly smaller than an empirically obtained mean difference between a variance of the electric power received by the receiving antenna 26, measured in the case where the obstacle is a walking pedestrian, and a variance of the electric power received by the receiving antenna 26, measured in the case where the obstacle is a stationary pedestrian.

In addition, the previously calculated variance V may be a value calculated immediately before or may be a value calculated a couple of steps before.

When the difference ΔV in the variance V is larger than or equal to the reference value V2, the pedestrian determination ECU 30 determines that the intended obstacle is a pedestrian, and changes the flag value *_Pdst from 0 to 1 (S308).

When it is determined in S300 that the flag value *_Pdst of the intended obstacle is 1 or when the flag value *_Pdst is changed from 0 to 1 in S308, the pedestrian determination ECU 30 sets the threshold for determining the above-described obstacle to RLow (S310). The threshold Rlow is preset to a low value at which it is possible to continuously recognize a stationary pedestrian.

Then, the pedestrian determination ECU 30 outputs data of distance, direction and relative velocity about the intended obstacle to the pedestrian protection apparatus 40 (S312).

On the other hand, when it is determined in S306 that the difference ΔV in the variance V is smaller than the reference value V2, the pedestrian determination ECU 30 keeps the flag value *_Pdst at 0, and sets the threshold for determining the obstacle to RHigh (S314). The threshold RHigh is larger than the threshold Rlow. In this way, when it is determined that the obstacle is not a pedestrian, the threshold for determining the obstacle is kept higher, so it is possible to suppress erroneous detection of an obstacle.

Note that, in the above description, only when it is determined that the obstacle is a pedestrian, data of distance, direction and relative velocity are output to the pedestrian protection apparatus 40; instead, for example, in any cases, data of distance, direction and relative velocity may be output to the pedestrian protection apparatus 40 together with the flag value *_Pdst. The example embodiment of control may be modified into various forms.

Then, until the intended obstacle is lost, the processes of S300 to S314 are repeatedly executed (S316).

Note that, in the second embodiment as well, as in the case of the first embodiment, the details of the processes may be modified such that, after it is determined that an obstacle is a pedestrian, the obstacle is identified as a pedestrian until a set period of time elapses (or the vehicle travels a predetermined distance) (see FIG. 6).

With the above-described pedestrian detecting device for vehicle 10 according to the present embodiment, after it is determined that an obstacle is a pedestrian on the basis of whether a variation of the variance V of the electric power received by the receiving antenna 26 in a set period of time is larger than or equal to the reference value V2, the obstacle is identified as a pedestrian until the obstacle is lost (or until a set period of time elapses). Therefore, it is possible to continuously track a stationary pedestrian, and it is possible to further reliably track a pedestrian.

In addition, after an obstacle is identified as a pedestrian, the obstacle is identified while decreasing the threshold, so it is possible to suppress an inconvenience that an obstacle determined as a pedestrian is lost.

In addition, with the pedestrian protection system for vehicle 1 according to the present embodiment, a pedestrian is identified by utilizing an output of the pedestrian detecting device for vehicle 10, so it is possible to further appropriately activate the pedestrian protection apparatus 40.

The embodiments of the invention are described above; however, the invention is not limited to the above-described embodiments. Various modifications and replacements may be added without departing from the scope of the invention.

1-8. (canceled)

9. A pedestrian detecting device for vehicle comprising:
a transmission unit that irradiates an electromagnetic wave to an area around a vehicle;
a receiving unit that receives a reflected wave caused by reflection of the electromagnetic wave from an obstacle;
a storage unit that stores data regarding the reflected wave received by the receiving unit; and
a control unit configured to:
(a) read the data, stored in the storage unit, and output positional information about the obstacle;
(b) calculate a variance of an intensity of the reflected wave;
(c) determine that the obstacle is a pedestrian when a variation of the calculated variance of the intensity of the reflected wave in a set period of time is larger than or equal to a reference value; and
(d) output information regarding a position of the pedestrian.

10. The pedestrian detecting device for vehicle according to claim 9, wherein
the control unit identifies the same obstacle as the pedestrian during a set period of time after the control unit determines that the obstacle is the pedestrian.

11. The pedestrian detecting device for vehicle according to claim 9, wherein
the control unit identifies a presence of an obstacle when the intensity of the reflected wave is higher than or equal to a threshold, and
after the control unit determines that the obstacle is a pedestrian, the control unit decreases the threshold applied for the same obstacle.

12. The pedestrian detecting device for vehicle according to claim 9, wherein
the electromagnetic wave irradiated to the area around the vehicle is a 24-GHz-band narrow band.

13. A pedestrian protection system for vehicle comprising:
a transmission unit that irradiates an electromagnetic wave to an area around a vehicle;
a receiving unit that receives a reflected wave caused by reflection of the electromagnetic wave from an obstacle;
a storage unit that stores data regarding the reflected wave received by the receiving unit; and
a control unit configured to:
(a) read the data, stored in the storage unit, and output positional information about the obstacle;
(b) calculate a variance of an intensity of the reflected wave;
(c) determine that the obstacle is a pedestrian when a variation of the calculated variance of the intensity of the reflected wave in a set period of time is larger than or equal to a reference value; and
(d) output information regarding a position of the pedestrian; and
a pedestrian protection apparatus configured to activate on the basis of the positional information about the obstacle, output from the pedestrian control unit.

14. A pedestrian determination method for vehicle, the vehicle including a transmission unit, a receiving unit, a storage unit, and a control unit, the method comprising:
irradiating, by the transmission unit, an electromagnetic wave to an area around a vehicle;
receiving, by the receiving unit, a reflected wave caused by reflection of the electromagnetic wave from an obstacle;
storing, by the storage unit, data regarding the reflected wave;
reading, by the control unit, the data and calculating, by the control unit, a variance of an intensity of the reflected wave; and
when a variation in the variance of the intensity of the reflected wave in a set period of time is larger than or equal to a reference value, determining, by the control unit, that the obstacle is a pedestrian.
